(19) United States
(12) Patent Application Publication
(10) Pub. No.: US 2016/0073073 A1
(43) Pub. Date: Mar. 10, 2016

(54) PORTABLE TERMINAL AND METHOD OF CONTROLLING THE SAME

(71) Applicant: SAMSUNG ELECTRONICS CO., LTD., Suwon-si (KR)

(72) Inventors: Jung Su HA, Suwon-si (KR); Bong-Gyo SEO, Suwon-si (KR); Hee Yeon JEONG, Seoul (KR); Jung Hyeon KIM, Yongin-si (KR)

(73) Assignee: SAMSUNG ELECTRONICS CO., LTD., Suwon-si (KR)

(21) Appl. No.: 14/820,091

(22) Filed: Aug. 6, 2015

(30) Foreign Application Priority Data
Sep. 5, 2014 (KR) 10-2014-0118854

(51) Int. Cl. H04N 9/31; G03B 21/20; G06F 3/01; H04B 1/3827

(52) U.S. Cl. CPC H04N 9/3173; H04B 1/385; H04N 9/317; H04N 9/3147; G03B 21/2033; G03B 21/2013; G03B 21/2066; G06F 3/017; H04B 2001/3861

(57) ABSTRACT

A portable terminal including a projector which projects a user interface (UI) onto an object, and a method of controlling the same. The portable terminal includes a display which displays a first UI and at least one projector which projects a second UI onto an object, and the at least one projector includes a light source which displays the second UI through a plurality of organic light-emitting diodes (OLEDs) and a lens which focuses light generated in the plurality of OLEDs and projects the light onto the object.

### CROSS-REFERENCE TO RELATED APPLICATION

This application claims the benefit of Korean Patent Application No. 2014-0118854, filed on Sep. 5, 2014 in the Korean Intellectual Property Office, the disclosure of which is incorporated herein by reference.

### BACKGROUND

1. Field

Embodiments of the present invention relate to a portable terminal which the user is able to carry and use for communication and a method of controlling the same.

2. Description of the Related Art

Typically, portable terminals are devices that users can carry and perform communication functions with other users such as voice calls or short message transmission, data communication functions such as the Internet, mobile banking, or multimedia file transfer, entertainment functions such as games, music or video playback, or the like.

Although portable terminals have generally specialized in an individual function such as a communication function, a game function, a multimedia function, an electronic organizer function, etc. In recent years, thanks to the development of electric/electronic technologies and communication technologies, users have been able to enjoy a variety of functions with only one mobile terminal.

For example, portable terminals may include smartphones, laptop computers, personal digital assistants (PDAs), tablet PCs, or the like, and wearable devices that are in direct contact with the body of a user and are portable.

As a representative example, wearable devices may include smart watches. In general, a user wears a smart watch on his or her wrist, and may input control commands through a touch screen provided on the smart watch or a separate input unit.

### SUMMARY

Therefore, it is an aspect of the present invention to provide a portable terminal including a projector which projects a UI onto an object, and a method of controlling the same.

Additional aspects of the invention will be set forth in part in the description which follows and, in part, will be obvious from the description, or may be learned by practice of the invention.

In accordance with one aspect of the present invention, a portable terminal includes a display which displays a first user interface (UI) and a projector which projects a second UI different from the first UI onto an object, and the projector includes a light source which displays the second UI through a plurality of organic light-emitting diodes (OLEDs) and a lens which focuses light generated in the plurality of OLEDs and projects the light onto the object.

The portable terminal may further include a housing having the display installed on an upper surface thereof.

The projector may be installed on one side surface which is in contact with the upper surface of the housing.

The lens may be provided so that curvature thereof is reduced away from the upper surface of the housing.

When the number of projectors is two, the two projectors may be installed on each of two facing side surfaces of the housing.

The housing may include a lifting member which lifts the projector above the upper surface.

The projector lifted by the lifting member may project the second UI at a location corresponding to a distance with the upper surface of the housing.

The housing may include a lower housing including a lower surface facing the upper surface and an upper housing on which the projector is installed and which is installed on the lower housing to be rotatable.

The portable terminal may further include a wrist band of which one end is connected to the housing and which fixes the lower surface facing the upper surface of the housing to be in contact with the object.

The portable terminal may further include a cradle coupled to the housing to fix a projection location of the projector.

The projector may further include a reflection mirror which changes a path of the light generated in the plurality of OLEDs and transfers the light to the lens.

The projector may project the second UI at a location corresponding to an angle at which the light generated in the plurality of OLEDs is incident on the reflection mirror.

The portable terminal may further include an input unit which receives an input of a command for projecting the second UI to the object and the projector may project the second UI onto the object according to the input command.

The portable terminal may further include a gesture sensor which detects a gesture with respect to a UI projected onto the object.

When the gesture sensor detects a predetermined gesture, the display may display the second UI or a third UI different from the second UI.

When the gesture sensor detects a predetermined gesture, the projector may project the first UI or a third UI different from the first UI onto the object.

In accordance with another aspect of the present invention, a portable terminal includes a projector which projects a first UI onto an object, a gesture sensor which detects a gesture with respect to the first UI, and a controller which controls the projector so that a second UI corresponding to the detected gesture is projected onto the object.

The projector may include a light source which displays the first UI or the second UI through a plurality of OLEDs and a lens which focuses light generated in the plurality of OLEDs and projects the light onto the object.

The lens may be provided so that curvature thereof is reduced in a predetermined direction.

The projector may further include a reflection mirror which changes a path of the light generated in the plurality of OLEDs and transfers the light to the lens.

The projector may project the first UI or the second UI at a location corresponding to an angle at which the light generated in the plurality of OLEDs is incident on the reflection mirror.

The portable terminal may further include a lifting member which moves the projector away from the object.

The projector moved by the lifting member may project the first UI or the second UI at a location corresponding to a distance with the object.

In accordance with another aspect of the present invention, a method of controlling a portable terminal includes projecting a first UI onto an object, detecting a gesture with respect to the first UI, and providing a second UI corresponding to the detected gesture.

The providing of the second UI corresponding to the detected gesture may include projecting the second UI corresponding to the detected gesture onto the object.

The providing of the second UI corresponding to the detected gesture may include displaying the second UI corresponding to the detected gesture on the display.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating an appearance of a portable terminal;

FIG. 2 is a control block diagram illustrating a portable terminal according to one embodiment of the present invention;

FIG. 3 is a view for describing locations at which a projector and a gesture sensor are provided in a portable terminal according to one embodiment of the present invention;

FIG. 4 is a view for describing a method of projecting a user interface (UI) in a portable terminal according to one embodiment of the present invention;

FIGS. 5A and 5B are views for describing a method of displaying a UI for video calls in a portable terminal according to one embodiment of the present invention;

FIGS. 6A to 6C are views for describing a method of displaying a UI for taking notes during a video call in a portable terminal according to one embodiment of the present invention;

FIGS. 7A to 7D are views for describing various examples of UIs projected onto an object in a portable terminal according to one embodiment of the present invention;

FIGS. 8A and 8B are views for describing a role of a lifting member in a portable terminal according to one embodiment of the present invention;

FIG. 9 is a view for describing a role of a cradle in a portable terminal according to one embodiment of the present invention;

FIG. 10 is a view for describing a method in which a portable terminal is used as a head up display (HUD) with a cradle according to one embodiment of the present invention;

FIG. 11 is a view for describing rotation of a housing in a portable terminal according to one embodiment of the present invention;

FIG. 12 is a view for describing a method of projecting a UI by rotating a housing in a portable terminal according to one embodiment of the present invention;

FIGS. 13 and 14 are view for describing various examples of a method of projecting a QWERTY keyboard in a portable terminal according to one embodiment of the present invention;

FIG. 15 is a view for describing a method of controlling a slide show in a portable terminal according to one embodiment of the present invention;

FIG. 16A is a view illustrating an appearance of a portable terminal according to another embodiment of the present invention and FIG. 16B is a view for describing a method of projecting a UI in the portable terminal according to another embodiment of the present invention;

FIG. 17 is a flowchart for describing a method of controlling a portable terminal according to one embodiment of the present invention;

FIG. 18 is a flowchart for describing a method of controlling a portable terminal according to another embodiment of the present invention; and

FIG. 19 is a flowchart for describing a method of controlling a portable terminal according to still another embodiment of the present invention.

### DETAILED DESCRIPTION

Hereinafter, a portable terminal 1 and a method of controlling the same will be described in detail with reference to the accompanying drawings.

The portable terminal 1 to be described below may refer to a device which is portable and transmits and receives data including voice and image information to and from an electronic device, a server, the other portable terminal 1, etc. The portable terminal 1 may include a mobile phone, a smart phone, a digital broadcasting terminal, a personal digital assistant (PDA), a portable multimedia player (PMP), a camera, navigation, a tablet PC, an e-book terminal, wearable device, or the like, and the portable terminal 1 will be assumed to be a smart watch in the following description.

An object Ob to be described below may be a hand including a wrist of a user. However, in some of the following embodiments, the object Ob may be a surface, for example, a table D or windshield glass W of a vehicle or a wall. However, since these are only various examples of the object Ob, the object Ob may include all objects onto which a user interface (UI) may be projected.

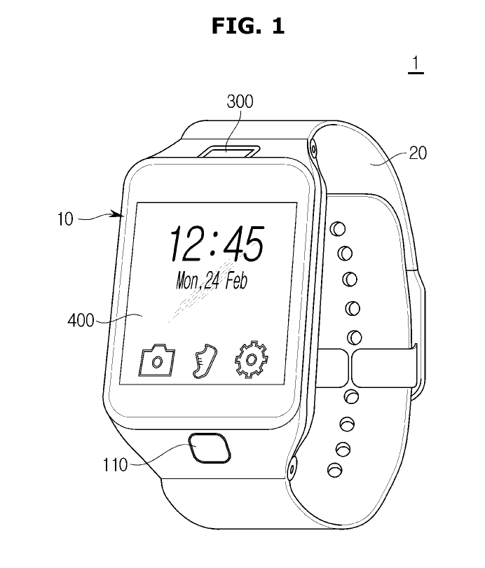

FIG. 1 is a view illustrating an appearance of the portable terminal 1. Specifically, FIG. 1 illustrates an appearance of a smart watch which is an example of the portable terminal.

The smart watch of the portable terminal 1 may be a device which is worn on the wrist of the user, displays current time information and information on objects, and performs control and other operations on the objects.

The portable terminal 1 of FIG. 1 may include a housing 10, a display 400 which is installed on an upper surface of the housing 10 and displays a UI, a wrist band 20 of which one end is connected to the housing 10 and which fixes a lower surface facing the upper surface of the housing 10 to be in contact with the object Ob. The portable terminal may further include a camera 300 which captures an image and an input unit 110 which receives control commands input by the user.

The user may bring the lower surface of the housing 10 in contact with the object Ob, specifically, his or her wrist. Further, the wrist band 20 surrounds the wrist while maintaining the contact, and thus a location of the housing 10 may be fixed. When the location of the housing 10 is fixed, a location of the display 400 provided on the upper surface of the housing 10 may also be fixed.

The display 400 may display UIs for providing functions of the portable terminal 1, receiving the control commands from the user, or providing a variety of information. To this end, the display 400 may be implemented by a self-emissive type display panel 400 which electrically excites fluorescent organic compound such as an organic light emitting diode (OLED) to emit light, or a non-emissive type display panel 400 which requires a separate light source as a liquid crystal display (LCD).

The user may determine the UI displayed on the display 400 and input a desired control command through the input unit 110. In this case, the input unit 110 may be provided as a separate component, or may be included in the display 400 implemented to include a touch panel in addition to the display panel. Alternatively, it may be possible that the above-described two examples co-exist.

The display 400 will be assumed to include the touch panel in the following description.

In FIG. 1, the UI displayed on the display 400 may provide a date and time for the user. In addition, the display 400 may provide a UI for photography with the camera 300, a UI for displaying stored multimedia, a UI for communication with a portable terminal of the other user, a UI for providing user biometric data such as a heart rate, a UI for the Internet, or a UI for settings of the portable terminal 1.

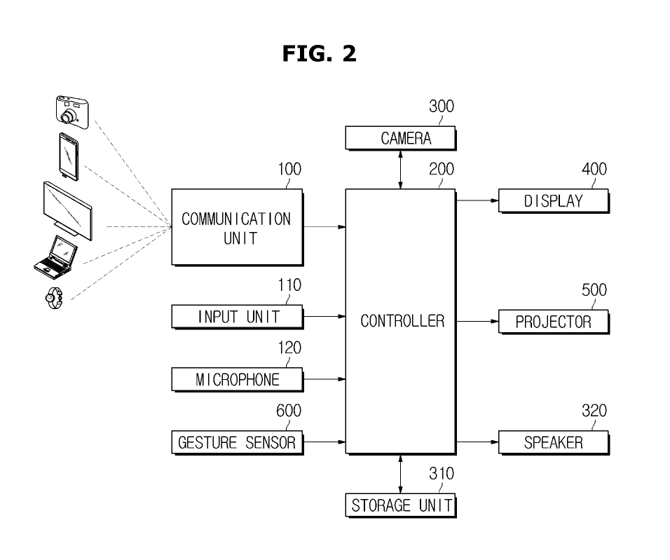

FIG. 2 is a control block diagram illustrating a portable terminal according to one embodiment of the present invention.

A portable terminal 1 according to one embodiment of the present invention may include a communication unit 100 which transmits or receives data to or from the outside, an input unit 110 which receives control commands input by the user, a microphone 120 which obtains voice of the user, a camera 300 which captures images, a storage unit 310 which stores various pieces of data for control of multimedia or the portable terminal 1, a display 400 which displays UIs, a speaker 320 which outputs sounds, and a controller 200 (for example, one or more computer processors) which controls the whole portable terminal 1.

The communication unit 100 may be directly or indirectly connected to external devices to transmit or receive data, and may transfer results of the transmission or reception to the controller 200. As illustrated in FIG. 2, the external device may include a camera, a mobile phone, a TV, a laptop computer, or a smart watch, which is capable of communicating, but the present invention is not limited thereto.

Specifically, the communication unit 100 may be directly connected to the external device, or may be indirectly connected to the external device through a network. When the communication unit 100 is directly connected to the external device, the communication unit 100 may be connected to the external device in a wired manner to exchange data. Alternatively, it may be possible that the communication unit 100 exchanges data with the external device through wireless communication.

When the communication unit 100 communicates with the external device through the wireless communication, the communication unit 100 may employ a protocol for global system for mobile communication (GSM), enhanced data GSM environment (EDGE), wideband code division multiple access (WCDMA), code division multiple access (CDMA), time division multiple access (TDMA), Bluetooth, Bluetooth low energy (BLE), near field communication (NFC), ZigBee, wireless fidelity (Wi-Fi) (e.g., IEEE802.11a, IEEE802.11b, IEEE802.11g and/or IEEE802.11n), a voice over Internet protocol (VoIP), Wi-MAX, Wi-Fi Direct (WFD), ultra wide band (UWB), infrared data association (IrDA), email, instant messaging, and/or short message service (SMS), or other appropriate communication protocols.

The input unit 110 may receive a control command for controlling the portable terminal 1 input by the user and transfer the input control command to the controller 200. The input unit 110 may be implemented as a key pad, a dome switch, a jog wheel, or a jog switch, and included in the display 400 when the display 400 to be described below is implemented as a touch screen.

The microphone 120 may detect a sound wave surrounding the portable terminal 1 and convert the detected sound wave into an electrical signal. The microphone 120 may transfer the converted sound signal to the controller 200.

The microphone 120 may be directly installed on the portable terminal 1 or detachably provided to the portable terminal 1.

The camera 300 may capture a static image or a dynamic image of a subject near the portable terminal 1. As a result, the camera 300 may obtain an image for the subject, and the obtained image may be transferred to the controller 200.

Although a case in which the camera 300 is provided on the housing 10 is illustrated in FIG. 1, the camera 300 may be provided on the wrist band 20 or may be detachably implemented to the housing 10 or the wrist band 20.

The storage unit 310 may store a UI or multimedia to be provided to the user, reference data for controlling the portable terminal 1, etc.

The storage unit 310 may include a non-volatile memory such as a read only memory (ROM), a high-speed random access memory (RAM), a magnetic disk storage device, or a flash memory device, or other non-volatile semiconductor memory devices.

For example, the storage unit 310 may include a semiconductor memory device such as a secure digital (SD) memory card, an SD high capacity (SDHC) memory card, a mini SD memory card, a mini SDHC memory card, a trans flash (TF) memory card, a micro SD memory card, a micro SDHC memory card, a memory stick, a compact flash (CF) memory card, a multi-media card (MMC), a MMC micro card, an extreme digital (XD) card, etc.

Further, the storage unit 310 may include a network-attached storage device accessed through a network.

The controller 200 may control the portable terminal 1 based on the received data in addition to the data stored in the storage unit 310.

For example, when the user wants to make a video call, the controller 200 may control the portable terminal 1 in the following manner.

First, the controller 200 may determine whether a video call request command is received or not from the input unit 110. When it is determined that the user inputs the video call request command to the input unit 110, the controller 200 may bring a UI for a video call stored in the storage unit 310 and display the UI on the display 400. Further, the controller 200 may be connected to the external device that the user wants to make the video call through the communication unit 100. When the controller 200 is connected to the external device, the controller 200 may receive the sound obtained by the microphone 120 and the image captured by the camera 300 to transfer the sound and the image to the external device through the communication unit 100. Further, the controller 200 may classify data received through the communication unit 100 into sound data and image data. As a result, the controller 200 may control the display 400 to display an image based on the image data and the speaker 320 to output a sound based on the sound data.

In addition to the above-described examples, the controller 200 may control functions such as a voice call, photo capturing, video capturing, voice recording, Internet connection, multimedia output, navigation, etc.

Meanwhile, it may be preferable that the portable terminal 1 be small in size so that the user may easily carry it. However, a decrease in size of the UI provided by the portable terminal 1 has a problem in that it provides difficulties in operating the portable terminal 1 for the user.

Therefore, as illustrated in FIG. 2, the portable terminal 1 according to one embodiment of the present invention may further include a projector 500 which projects the UIs onto the object Ob. In this case, the UI projected by the projector 500 may be the same as or different from the UI displayed on the display 400.

Specifically, the projector 500 may include a light source in which a plurality of organic light-emitting diodes (OLEDs) are arranged in a two dimension, and a lens which focuses light generated in the plurality of OLEDs to project onto the object Ob.

The light source may display a UI to be projected through the plurality of OLEDs. That is, the plurality of OLEDs arranged in a two dimension may display each of pixels of the UI to be projected.

The lens may focus the light generated in this manner. Particularly, a convex lens may be applied in order to expand the UI projected onto the object Ob.

In this case, a path of the light which is projected onto the object Ob by the lens may be changed according to a location onto which the object Ob is projected. Specifically, light which is incident on a portion adjacent to the object Ob, among incident surfaces of the lens, that is, a portion close to the lower surface of the housing 10, may have a path projected onto the object Ob, which is shorter than light which is incident on a portion away from the object Ob, that is, a portion close to the upper surface of the housing 10. As a result, the UI of a portion close to the lens, among the UIs projected onto the object Ob may be displayed smaller than that of a portion away from the lens.

In order to correct such distortions, the lens may be provided so that curvature thereof is reduced away from the upper surface of the housing 10. As a result, the light which is incident on the portion away from the object Ob, among the incident surfaces of the lens may be refracted further than the light which is incident on the portion adjacent to the object Ob, and a UI in a constant size may be projected onto the object Ob regardless of a distance with the lens.

Further, the projector 500 may further include a reflection mirror which changes the path of the light generated in the OLEDs to transfer the light to the lens. In this case, the projector 500 may project the UI at a location corresponding to an angle at which the light generated in the OLEDs is incident on the reflection mirror.

Since the light source should be installed on the miniaturized portable terminal 1, a region of the object Ob onto which the UI is projected may be limited. However, the path of the light generated from the light source is controlled using the reflection mirror, and thus the region onto which the UI is projected may be expanded.

In addition, as illustrated in FIG. 2, the portable terminal 1 may further include a gesture sensor 600 which detects a gesture with respect to the UI projected onto the object Ob.

The gesture sensor 600 may be installed on one surface of the housing 10 on which the projector 500 is installed. As a result, the gesture sensor 600 may detect the gesture of the user with respect to the UI projected by the projector 500. The gesture sensor 600 may transfer the detected gesture to the controller 200.

The gesture sensor 600 may be implemented as an infrared sensor. Specifically, the infrared sensor may irradiate a predetermined region with infrared rays and receive the infrared rays reflected from the predetermined region. When movement occurs in a region to which the infrared rays are applied, a change of the received infrared rays may be detected, and thus the infrared sensor may detect a gesture based on such a change.

Alternatively, the gesture sensor 600 may be implemented as an ultrasonic sensor. That is, the ultrasonic sensor may radiate ultrasound in real time, receive echo ultrasound, and detect the gesture based on a change of the echo ultrasound.

When the gesture sensor 600 detects the gesture, the controller 200 may control the portable terminal 1 according to the detected gesture. For example, when the gesture sensor 600 detects a predetermined gesture, the controller 200 may control the UI displayed on the display 400 or the UI projected by the projector 500.

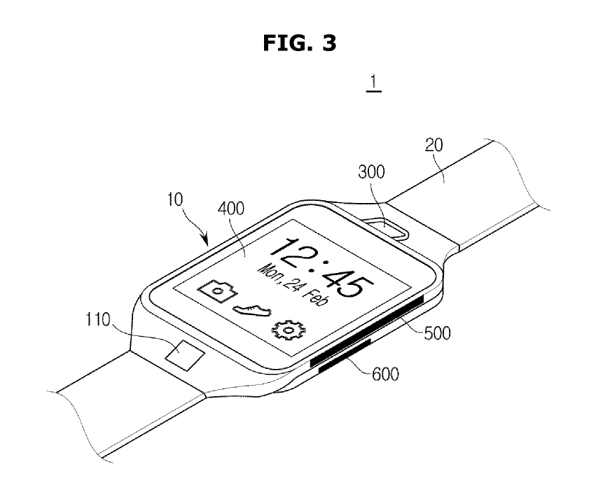

FIG. 3 is a view for describing locations at which a projector and a gesture sensor are provided in a portable terminal according to one embodiment of the present invention.

As described above, the display 400 may be provided on the upper surface of the housing 10. In this case, the projector 500 may be installed on one side surface in contact with the upper surface of the housing 10. Further, the gesture sensor 600 may be installed on the surface on which the projector 500 is installed.

FIG. 3 illustrates the case in which the projector 500 and the gesture sensor 600 are installed on any one of the other surfaces except for the surfaces to which the wrist band 20 is connected among side surfaces of the housing 10, specifically, on a right side surface. However, alternatively, the projector 500 and the gesture sensor 600 are installed on a left side surface of the housing 10.

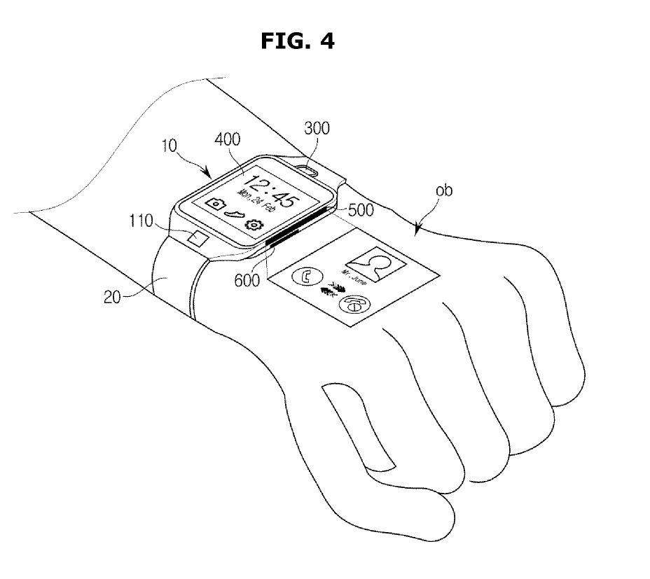

FIG. 4 is a view for describing a method of projecting a UI in a portable terminal according to one embodiment of the present invention.

FIG. 4 illustrates the case in which the portable terminal 1 contacts the object Ob, specifically, a left wrist of the user. In this case, the projector 500 installed on the right side surface of the portable terminal 1 may project an UI onto the object Ob, specifically, the back of the left hand of the user. The user may be further provided the UI projected onto the back of the hand in addition to the UI displayed through the display 400.

When the user generates a gesture with respect to the UI projected onto the back of the hand, the gesture sensor 600 provided in the same direction as the projector 500 may detect the gesture of the user to transfer the detected gesture to the controller 200. The controller 200 may control the portable terminal 1 according to the detected gesture.

Hereinafter, a method of displaying the UI through the projector 500 and controlling the portable terminal 1 according to the gesture of the user will be described.

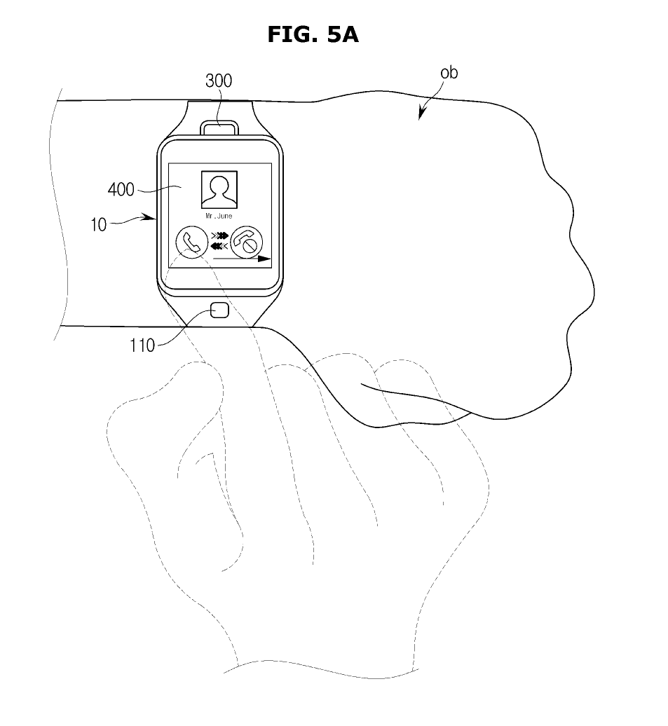

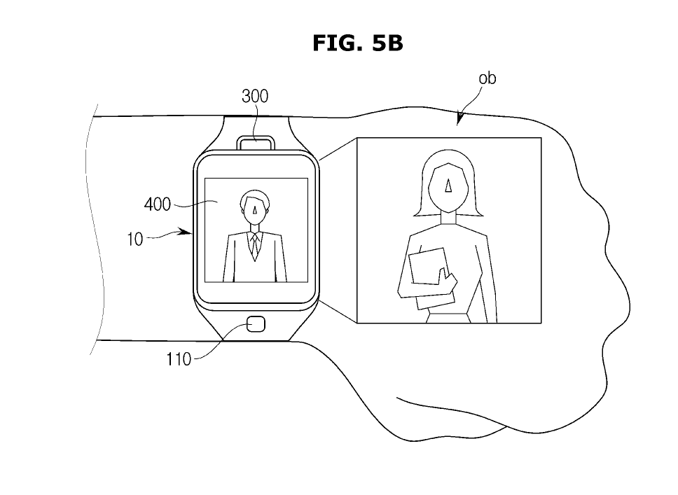

FIGS. 5A and 5B are views for describing a method of displaying a UI for video calls in a portable terminal according to one embodiment of the present invention.

A display 400 of FIG. 5A displays a UI of the case in which a call request comes from the other external portable terminal 1. When the user wants to call, the user may touch the display 400 to drag in a direction of an arrow.

As a result, a video call with the user of the other external portable terminal 1 may be started. Specifically, the display 400 and the projector 500 may provide the UI for video calls for the user.

For example, as illustrated in FIG. 5B, an image of the other party may be projected onto the back of the hand of the user and an image of the user obtained by the camera 300 may be displayed on the display 400. On the contrary, the own image may be projected onto the back of the hand of the user and the image of the other party may be displayed on the display 400.

As illustrated in FIG. 5B, the image of the user or other party may be projected onto the back of the hand of the user and thus a variety of information more than that provided by only the display 400 may be provided for the user.

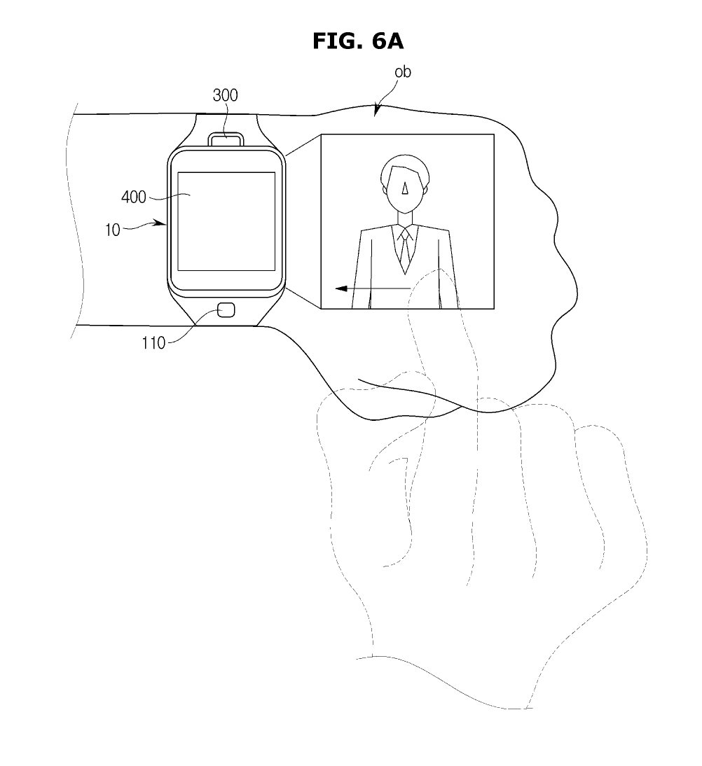

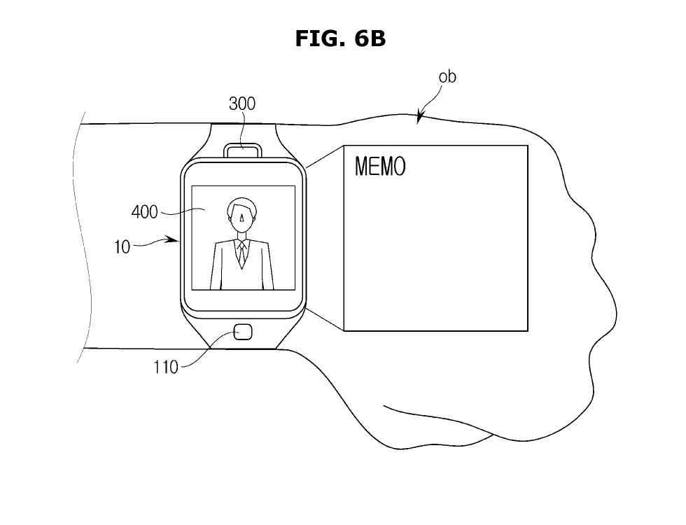

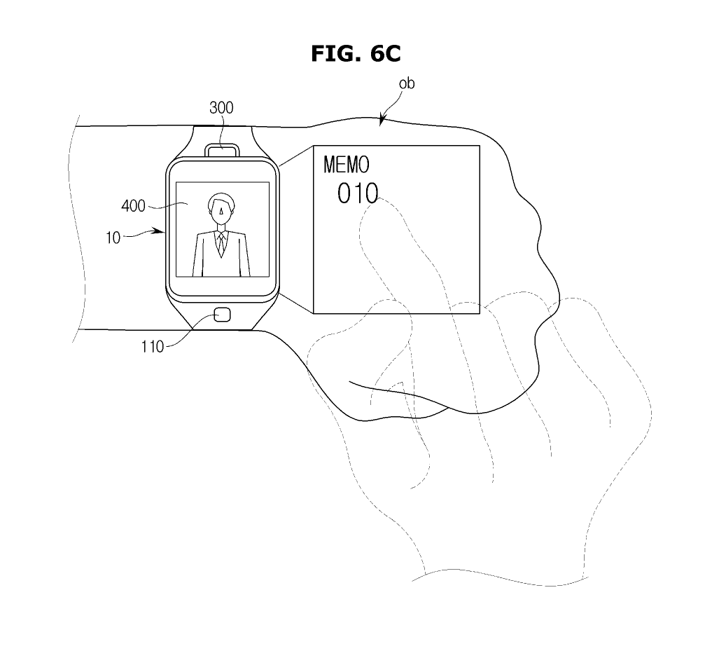

FIGS. 6A to 6C are views for describing a method of displaying a UI for taking notes during a video call in a portable terminal according to one embodiment of the present invention.

FIG. 6A illustrates the case in which the image of the user or other party in video calling is projected onto the back of the hand. FIG. 6A illustrates the case in which the display 400 does not display the UI, and however, the display 400 may display the image of the user or the other UI.

When the user needs to take notes during the call with the other party, the user may generate a gesture in a direction of an arrow with respect to the region onto which the image of the other party is projected.

The gesture may be detected by the gesture sensor 600. The controller 200 may control the projector 500 to project a UI for taking notes during the video call corresponding to the detected gesture onto the back of the hand.

For example, as illustrated in FIG. 6B, the image of the other party being projected onto the back of the hand may be displayed on the display 400. Further, the UI for taking notes may be displayed on the back of the hand. As described above, the user may use a note function while the user may be provided the image of the other party.

The user may generate a gesture of number input with respect to the UI for taking notes. As a result, the note result corresponding to the generated gesture may also be projected onto the back of the hand.

As illustrated in FIGS. 6A to 6C, the portable terminal 1 may provide the note function without interruption of the video call for the user using the projector 500 and the gesture sensor 600.

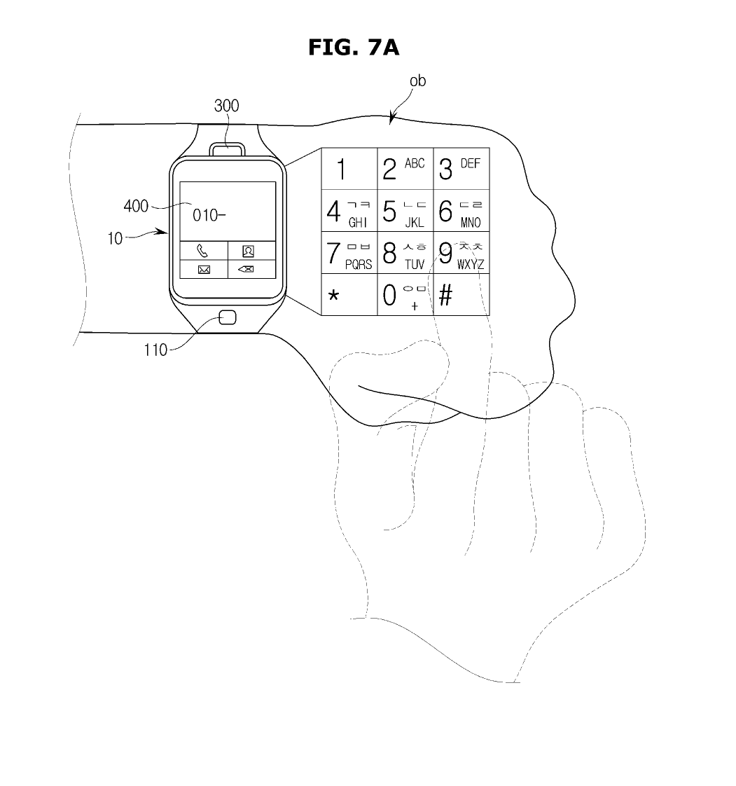

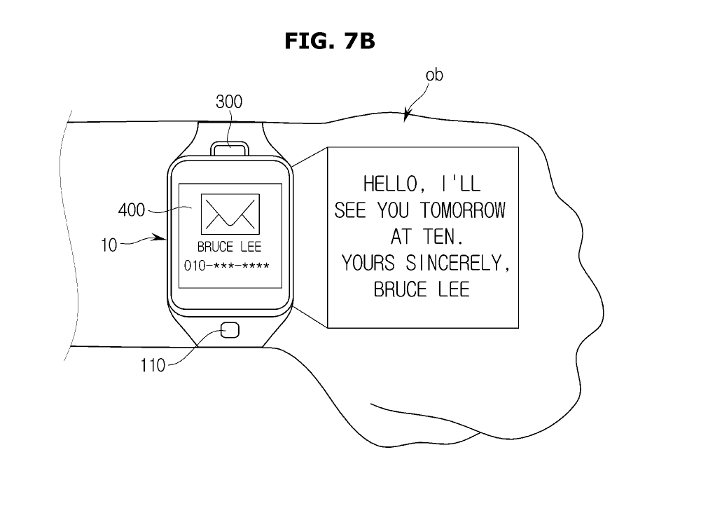

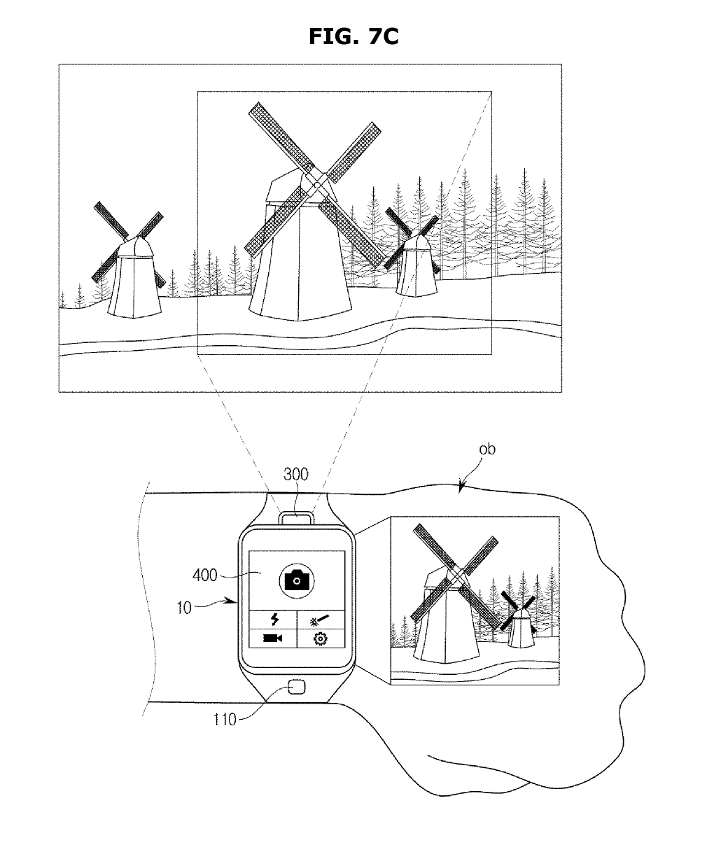

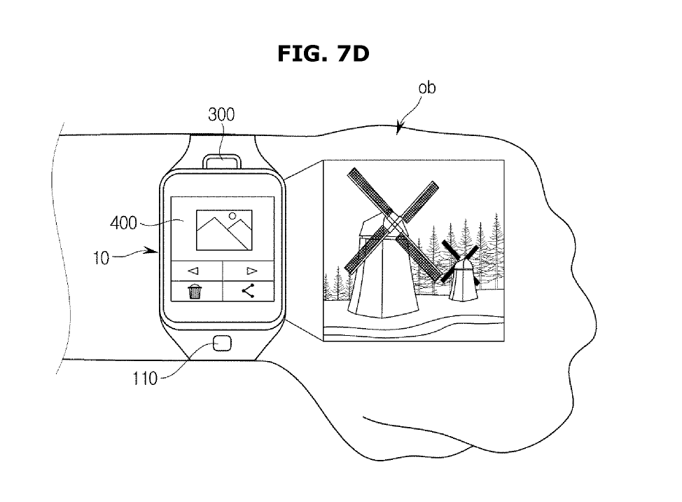

FIGS. 7A to 7D are views for describing various examples of UIs projected onto an object in a portable terminal according to one embodiment of the present invention.

FIG. 7A illustrates the case in which an UI for inputting a phone number is projected. Specifically, the projector 500 may project the UI for inputting a phone number onto the back of the hand. When a gesture which inputs the desired number with respect to the UI projected onto the back of the hand is generated by the user, the gesture sensor 600 may detect the gesture.

The display 400 may display a UI including the phone number corresponding to the detected gesture and items for performing functions according to the phone number.

The display 400 which depends on a size of the portable terminal 1 has a limit of a size of the displayed UI. When the size of the display 400 is small, the size of the UI provided through the display 400 for the user is small, and also there is a difficult problem when the control command through the touch panel of the display 400 is input.

However, as illustrated in FIG. 7A, the UI separated from the display 400 is displayed on the back of the hand, and thus it helps the user easily input the control command.

FIG. 7B illustrates the case in which a UI including text message information is projected. Specifically, the projector 500 may project the text message information onto the back of the hand. Further, the display 400 may display a caller phone number of the text message and a stored caller name corresponding to the phone number.

According to the portable terminal 1 of FIG. 7B, the UI is provided through the display 400 and the projector 500 for the user, an absolute amount of information that may be provided increases, and also, the UI of a further enlarged size is provided to help the user to recognize the information.

FIG. 7C illustrates the case in which a UI for capturing an image is projected. FIG. 7D illustrates the case in which a UI for displaying the captured image is projected.

As described above, the portable terminal 1 may include the camera 300. When the user wants to capture the image through the camera 300, as illustrated in FIG. 7C, the projector 500 may project the image detected by the camera 300 in real time onto the back of the hand. Further, the display 400 may display a UI including setting items for capturing the image. When the user captures a desired image on the back of the hand, the user may touch the display 400 to capture the image.

After the image capturing is completed, when the user wants to determine the image stored in the portable terminal 1, as illustrated in FIG. 7D, the projector 500 may project the captured image onto the back of the hand. Further, the display 400 may display the UI including the setting items with respect to the projected image.

As described above, the UIs provided by the projector 500 and the display 400 are separated from each other, and thus the user may be provided further variety information through the portable terminal 1.

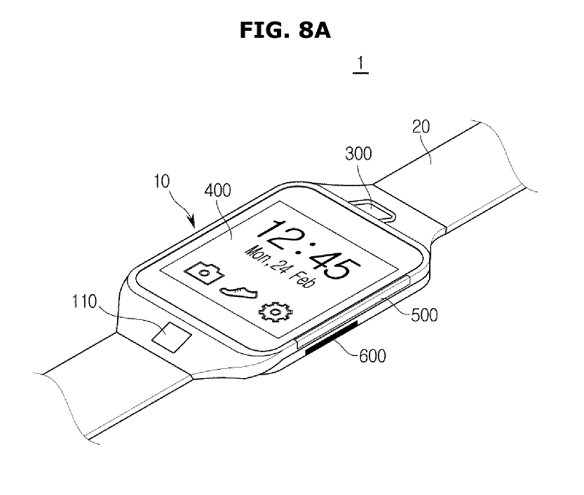

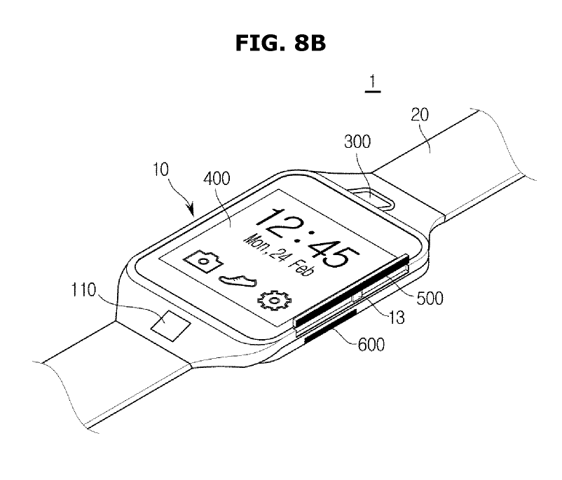

FIGS. 8A and 8B are views for describing a role of a lifting member 13 in a portable terminal according to one embodiment of the present invention.

The housing 10 of the portable terminal 1 may further include the lifting member 13 which lifts the projector 500 above the upper surface thereof.

As illustrated in FIG. 8A, the projector 500 may be detachably installed on one side surface of the housing 10. When a command is input by the user, as illustrated in FIG. 8B, the lifting member 13 may support a lower surface of the projector 500 and may be lifted so that the projector 500 is lifted. That is, the lifting member 13 may move the projector 500 away from the object Ob.

As a result, a region in which the UI is projected onto the object Ob may be moved away from the portable terminal 1. Specifically, the UI may be projected at a location corresponding to a distance between the projector 500 and the upper surface of the housing 10 or a distance between the projector 500 and the object Ob.

As described above, when the projector 500 is lifted through the lifting member 13, the projected region of the UI may be expanded.

FIGS. 8A and 8B illustrate the case in which the lifting member 13 is movable in a vertical direction. However, the lifting member 13 may rotate about a predetermined axis, the projector 500 is located above the upper surface of the housing 10, and thus the projector 500 may be away from the object Ob.

As described above, the object Ob has been assumed to be the back of the hand of the user in the above description. Hereinafter, the case in which the UI is projected onto the region other than the back of the hand of the user will be described.

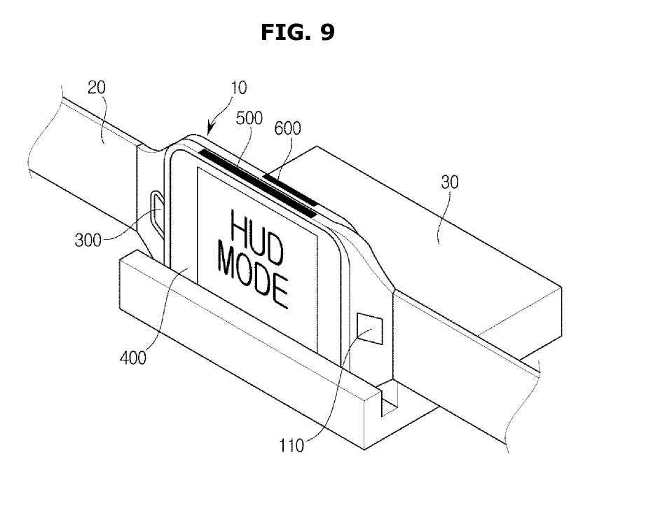

FIG. 9 is a view for describing a role of a cradle 30 in a portable terminal according to one embodiment of the present invention.

The portable terminal 1 may further include the cradle 30 coupled to the housing 10 to fix a projection location of the projector 500.

The cradle 30 may include a cradle groove. The cradle groove may have a greater thickness than the housing 10 of the portable terminal 1. As a result, the cradle groove may be coupled to the housing 10 of the portable terminal 1 to fix the location of the housing 10.

The portable terminal 1 may be used while fixed by the wrist of the user by the wrist band 20 and may be used while fixed by the cradle 30. According to the embodiment of the present invention, the portable terminal 1 may be fixed by the cradle 30 to be used as a head up display (HUD) of a vehicle.

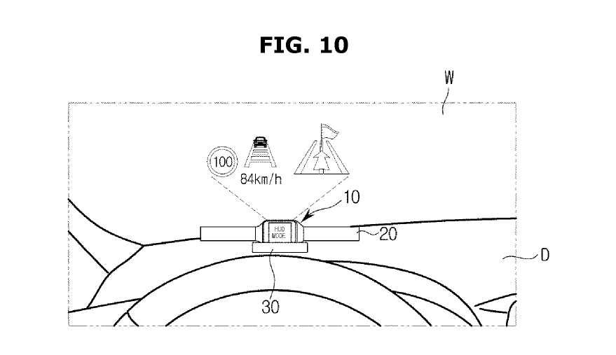

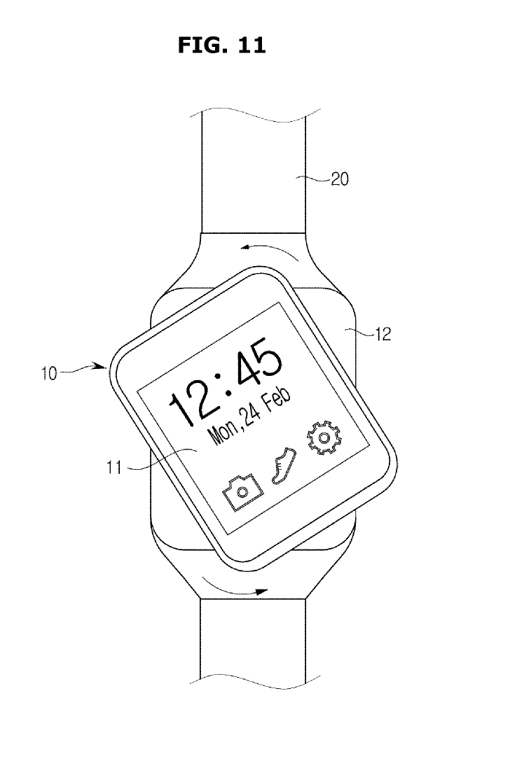

FIG. 10 is a view for describing a method in which a portable terminal 1 is used as a HUD by a cradle 30 according to one embodiment of the present invention.

As illustrated in FIG. 10, the cradle 30 may be located at a dashboard of a vehicle, and the housing 10 may be coupled to the cradle 30. When the housing 10 is fixed by the cradle 30, the projector 500 may also stably project a UI onto a fixed region.

Specifically, the projector 500 may project the UI onto windshield glass W of the vehicle. In this case, when the projector 500 projects a navigation UI, the portable terminal 1 may serve as the HUD of the vehicle.

FIG. 11 is a view for describing rotation of a housing in a portable terminal according to one embodiment of the present invention.

The housing 10 may include a lower housing 12 including a lower surface facing an upper surface thereof, and an upper housing 11 on which the projector 500 is installed and which is installed on the lower housing 12 to be rotatable.

In a state in which a location of the lower housing 12 is fixed, the upper housing 11 may rotate in a clockwise or counterclockwise direction. Referring to FIG. 11, the upper housing 11 on which the display 400 and the projector 500 are installed may rotate in a direction of an arrow, that is, in a counterclockwise direction.

As a result, a direction of the UI projected by the projector 500 may be changed.

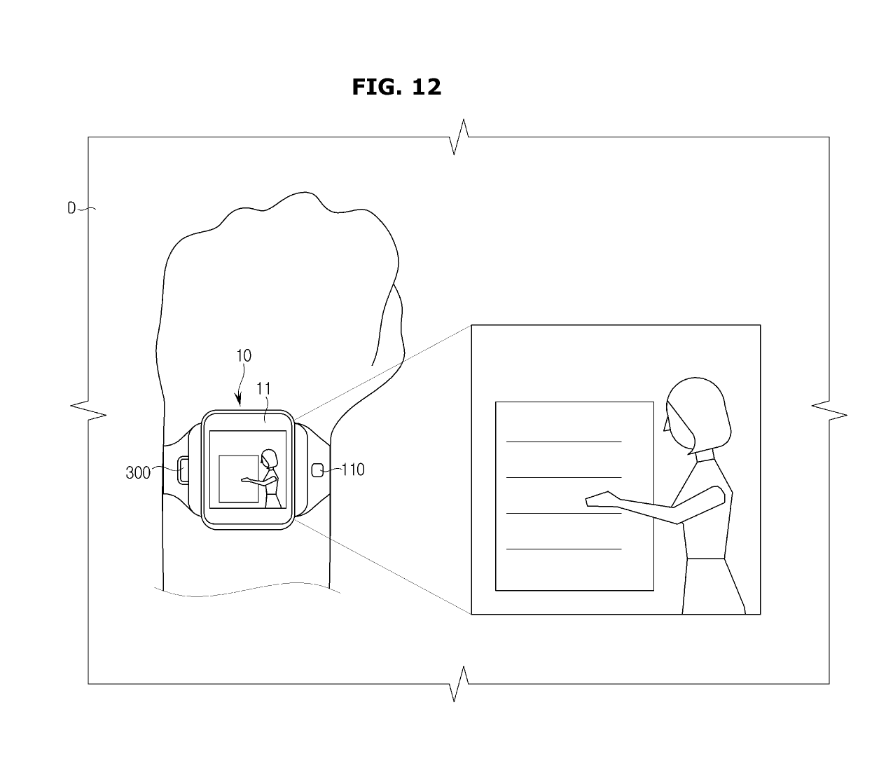

FIG. 12 is a view for describing a method of projecting a UI by rotating the housing in a portable terminal according to one embodiment of the present invention.

FIG. 12 illustrates the case in which the upper housing 11 rotates in a clockwise direction in a state in which the user fixes the portable terminal 1 to the wrist through the wrist band 20. Before the upper housing 11 rotates, the projector 500 may project the UI onto the back of the hand of the user. However, the upper housing 11 rotates, and thus, the projector 500 installed on the upper housing 11 may also rotate and a projection region of the UI may be changed.

When the user locates his hand at a table D while the user wears the portable terminal 1 of which the upper housing 11 rotates 90 degrees, as illustrated in FIG. 12, the UI may be projected onto the table D. In this case, a size of the UI projected by the projector 500 may further increased.

As described above, the upper housing 11 rotates, and thus the projection region of the UI may be adjusted according to convenience of the user.

As illustrated in FIG. 12, when the object Ob is the table D, the projector 500 may project the expanded UI to help to facilitate a user's input.

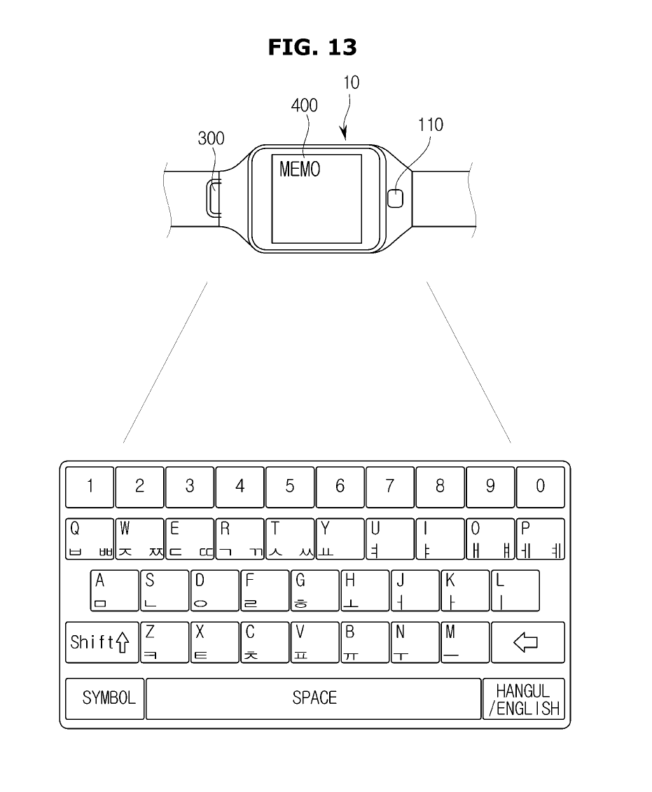

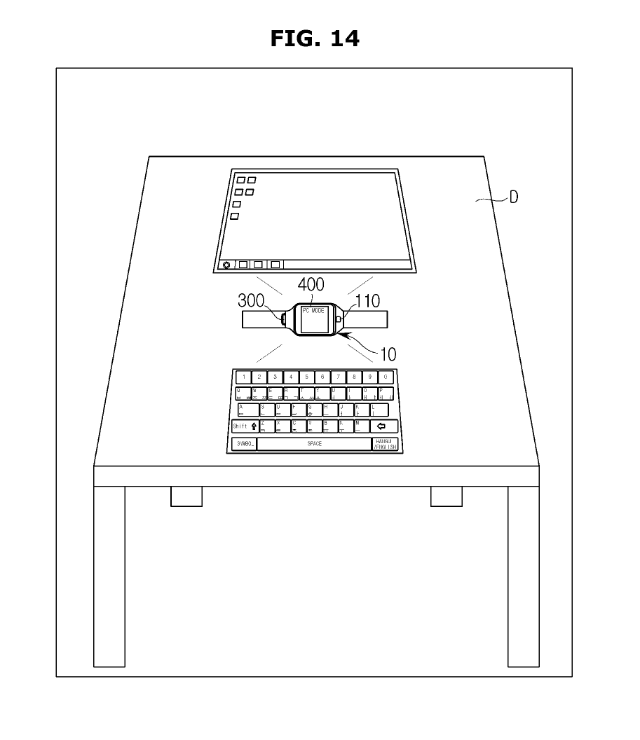

FIGS. 13 and 14 are view for describing various examples of a method of projecting a QWERTY keyboard in a portable terminal according to one embodiment of the present invention.

As illustrated in FIG. 13, the projector 500 of the portable terminal 1 located on a table D may project an UI for a QWERTY keyboard onto the table D. Further, the display 400 may display a UI for taking notes.

Since the user does not fix the portable terminal 1 to the wrist, the user may generate a gesture on the QWERTY keyboard using both hands. The gesture sensor 600 may detect the gesture of the user, and the controller 200 may control the display 400 to display a character corresponding to the detected gesture.

As described above, the projector 500 projects the UI for a QWERTY keyboard, and thus the user may further easily input the desired character.

FIG. 14 illustrates the case in which the portable terminal 1 includes two projectors 500. Specifically, the two projectors 500 may be installed on each of two facing side surfaces of the housing 10. For example, as illustrated in FIG. 14, the two projectors 500 may be installed on a right-side surface and a left-side surface, respectively, and, for example, in case of a rectangular housing 10 on a lengthwise (longer) side of the housing 10. A projector may be installed at one or any combination of other positions or locations of the housing 10.

In this case, UIs projected by the projectors 500 may be different from each other. Specifically, the projector 500 installed on one side surface may project the QWERTY keyboard as illustrated in FIG. 13. Further, the projector 500 installed on the other side surface may project an UI for a PC monitor.

As described above, when the portable terminal 1 including the two projectors 500 is located at the table D rather than the wrist of the user, two different UIs may be projected onto the table D, and particularly, may be used as a PC. As a result, a volume of the portable terminal 1 may be minimized and the portable terminal 1 may serve as a portable PC.

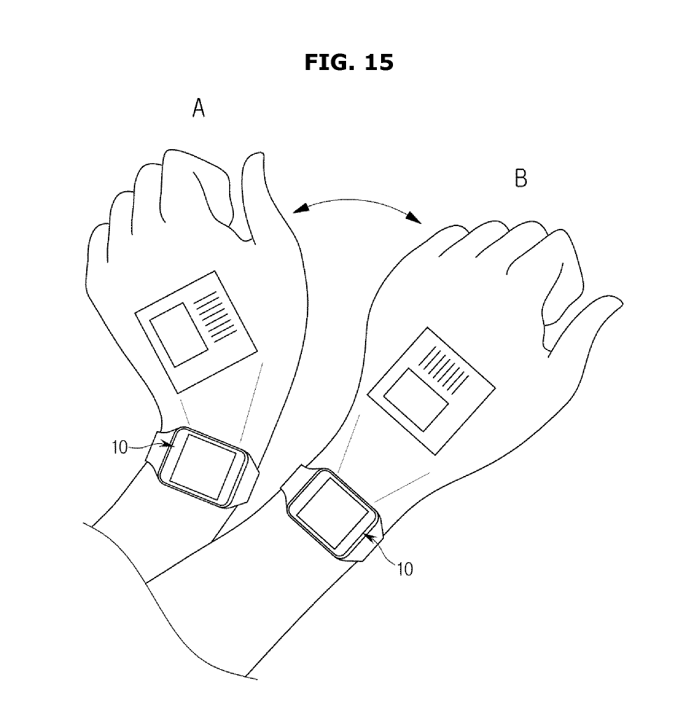

FIG. 15 is a view for describing a method of controlling a slide show in a portable terminal according to one embodiment of the present invention.

As described above, the portable terminal 1 may include the gesture sensor 600 installed in the same direction as the projector 500. In this case, the gesture sensor 600 may detect a gesture of the hand on which the portable terminal 1 is worn as well as a gesture of the hand on which the portable terminal 1 is not worn.

As illustrated in FIG. 15, when the gesture sensor 600 detects that the hand moves from a position A to a position B, the projector 500 may project the next page of the slide. On the contrary, when the gesture sensor 600 detects that the hand moves from the position B to the position A, the projector 500 may project the previous page of the slide.

In addition, according to the gesture detected by the gesture sensor 600, the portable terminal 1 may control a slide show of an external device. For example, when the portable terminal 1 is connected to an external laptop computer, the controller 200 may transmit a signal for controlling the slide show to the laptop computer through the communication unit 100 according to the detection of the gesture sensor 600. As a result, the laptop computer may display the previous page or the next page of the slide.

As described above, the portable terminal 1 including the display 400 in addition to the projector 500 has been described. Hereinafter, a portable terminal 1 including only the projector 500 will be described.

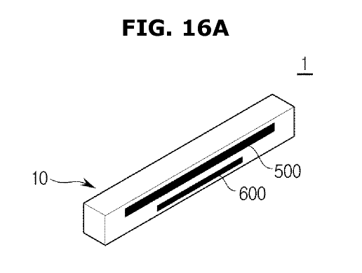

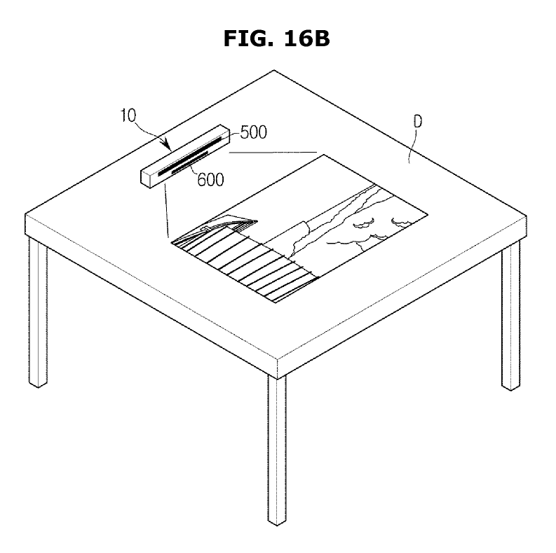

FIG. 16A is a view illustrating an appearance of a portable terminal according to another embodiment of the present invention and FIG. 16B is a view for describing a method of projecting a UI in the portable terminal according to another embodiment of the present invention.

Referring to FIG. 16A, the portable terminal 1 may include a projector 500 which projects a UI onto an object Ob, a gesture sensor 600 which detects a gesture with respect to the UI, and a controller 200 which controls the projector 500 to project the UI corresponding to the detected gesture onto the object Ob.

Since the projector 500, the gesture sensor 600, and the controller 200 which are components of FIG. 16A are all the same as described above, a detailed description thereof will be omitted.

As illustrated in FIG. 16A, when a display 400 is omitted, a volume of the portable terminal 1 may be further reduced. Therefore, the portable terminal 1 may be further easily portable.

Referring to FIG. 16B, when the portable terminal 1 is located on a table D, the projector 500 may project a UI onto the table D. When the UI is projected onto the table D, an expanded UI may be provided for the user.

Although the portable terminal 1 of a bar shape has been illustrated in FIGS. 16A and 16B, it may be provided in a form of the smart watch as described above.

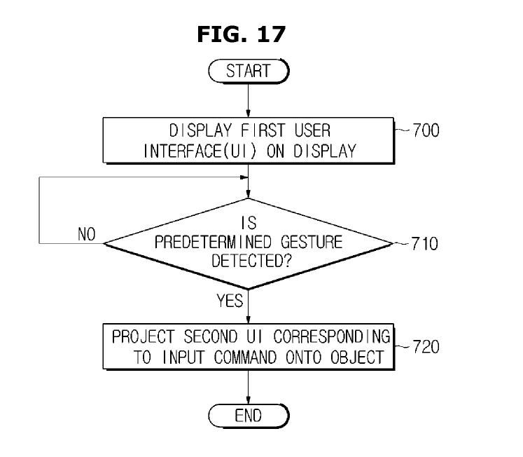

FIG. 17 is a flowchart for describing a method of controlling a portable terminal 1 according to one embodiment of the present invention. FIG. 17 illustrates the method of controlling the portable terminal 1 so that a projector 500 projects a UI.

First, a first UI may be displayed on a display 400 (S700). In this case, the first UI may include information on the portable terminal 1, items for selecting functions of the portable terminal 1, etc.

Then, it is determined whether a predetermined command is input or not through the first UI (S710). In this case, the predetermined command may be a command to project a second UI through the projector 500.

The user may input the predetermined command through an input unit 110. Particularly, the input unit 110 may be implemented as a touch panel of the display 400 to be included in the display 400.

As an example, the predetermined command may include the touch input of FIG. 5A and a description thereof will be omitted. As an example, a UI displayed on the display 400 can be moved to be projected onto the object through an input command, for example, by way of a touch to drag on the display 400 in the direction of the object.

When the predetermined command is not input, it may be repeatedly determined whether the command is input or not.

On the other hand, when the predetermined command is input, the second UI corresponding to the input command may be projected onto the object Ob (S720). When the predetermined command is the same as the touch input of FIG. 5A, the projector 500 may project the image as illustrated in FIG. 5B onto the object Ob.

Here, the second UI may be a UI different from the first UI. However, the projector 500 may project the first UI the same as the display 400 onto the object Ob unlike FIG. 17.

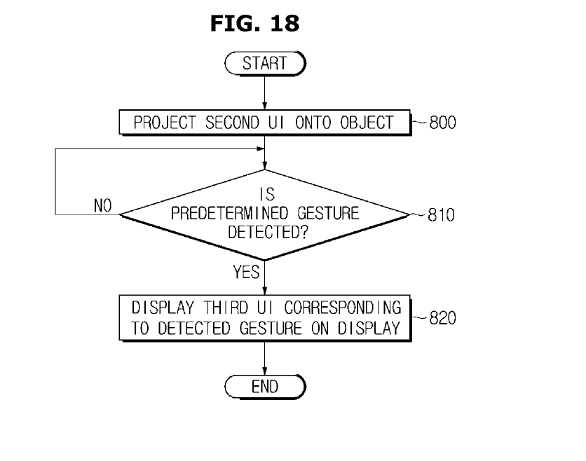

FIG. 18 is a flowchart for describing a method of controlling a portable terminal according to another embodiment of the present invention. FIG. 18 illustrates the method of controlling the display of a display 400 according to a gesture with respect to a projected second UI.

First, the second UI may be projected onto an object Ob (S800). To this end, a projector 500 may project the second UI using a plurality of OLEDs.

Then, it is determined whether a predetermined gesture is detected or not through the second UI (S810). In this case, the predetermined gesture may be a gesture corresponding to a command to display a third UI through the display 400.

In order to detect the predetermined gesture, a gesture sensor 600 may be used. In this case, the gesture sensor 600 may be implemented as an infrared sensor or an ultrasonic sensor.

As an example, the predetermined gesture may include the gesture illustrated in FIG. 6A and a description thereof will be omitted.

When the predetermined gesture is not detected, it may be repeatedly determined whether the gesture is detected or not.

On the other hand, when the predetermined gesture is detected, the third UI corresponding to the detected gesture may be displayed on the display 400 (S820). When the predetermined gesture is the same as the gesture illustrated in FIG. 6A, the display 400 may display the image as illustrated in FIG. 6B.

Here, the third UI may be a UI different from the second UI. However, the display 400 may display the second the same as the projector 500 unlike FIG. 18.

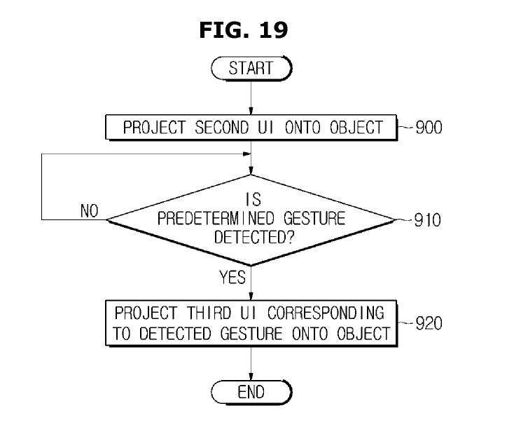

FIG. 19 is a flowchart for describing a method of controlling a portable terminal according to still another embodiment of the present invention. FIG. 19 illustrates the method of controlling a UI projected according to a gesture with respect to a projected second UI.

First, the second UI may be projected onto an object Ob (S900).

Then, it is determined whether a predetermined gesture is detected or not through the second UI (S910). In this case, the predetermined gesture may be a gesture corresponding to a command to project a third UI through a projector 500.

In order to detect the predetermined gesture, a gesture sensor 600 may be used as illustrated in FIG. 18.

As an example, the predetermined gesture may include the gesture illustrated in FIG. 6A, and a description thereof will be omitted.

When the predetermined gesture is not detected, it may be repeatedly determined whether the gesture is detected or not.

On the other hand, when the predetermined gesture is detected, the third UI corresponding to the detected gesture may be projected onto the object Ob (S920). When the predetermined gesture is the same as the gesture illustrated in FIG. 6A, the projector 500 may project the image onto the object Ob as illustrated in FIG. 6B.

Here, the third UI may be a UI different from the second UI. However, a display 400 may display the second UI the same as the projector 500 unlike FIG. 19.

As is apparent from the above description, according to a portable terminal and a method of controlling the same in accordance with one embodiment of the present invention, a UI having a larger area than a display of the portable terminal is projected, and thus the user can easily input.

According to a portable terminal and a method of controlling the same in accordance with another embodiment of the present invention, a UI different from a UI displayed on a display of the portable terminal is projected, and thus the user can be provided with various UIs.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A portable terminal comprising:
a display configured to display a first user interface (UI); and
at least one projector configured to project a second UI separate from the first UI onto an object,
wherein the at least one projector includes:
a light source configured to display the second UI through a plurality of organic light-emitting diodes (OLEDs); and
a lens configured to focus light generated in the plurality of OLEDs and project the light onto the object.

2. The portable terminal according to claim 1, further comprising a housing having the display installed on an upper surface of the housing.

3. The portable terminal according to claim 2, wherein the projector is installed on one side surface which is in contact with the upper surface of the housing.

4. The portable terminal according to claim 3, wherein the lens is provided so that curvature thereof is reduced away from the upper surface of the housing.

5. The portable terminal according to claim 3, wherein, when a number of the at least one projector is two, the two projectors are installed on each of two facing side surfaces of the housing which are in contact with the upper surface of the housing.

6. The portable terminal according to claim 2, wherein the housing includes a lifting member configured to lift the at least one projector above the upper surface.

7. The portable terminal according to claim 6, wherein the at least one projector lifted by the lifting member projects the second UI at a location corresponding to a distance with the upper surface of the housing.

8. The portable terminal according to claim 2, wherein the housing includes:
a lower housing including a lower surface facing the upper surface; and
an upper housing on which the projector is installed and which is installed on the lower housing to be rotatable.

9. The portable terminal according to claim 2, further comprising a wrist band of which one end is connected to the housing and configured to couple to a lower surface facing the upper surface of the housing.

10. The portable terminal according to claim 2, further comprising a cradle coupled to the housing to position a projection location of the projector.

11. The portable terminal according to claim 1, wherein the least one projector further includes a reflection mirror configured to change a path of the light generated in the plurality of OLEDs and transfer the light to the lens.

12. The portable terminal according to claim 11, wherein the at least one projector projects the second UI at a location corresponding to an angle at which the light generated in the plurality of OLEDs is incident on the reflection mirror.

13. The portable terminal according to claim 1, further comprising an input unit configured to receive an input of a command,
wherein the at least one projector projects the second UI onto the object according to the input command.

14. The portable terminal according to claim 1, further comprising a gesture sensor configured to detect a gesture corresponding to the second UI projected onto the object.

15. The portable terminal according to claim 14, wherein, when the gesture sensor detects the gesture, the display displays the second UI or a third UI different from the second UI.

16. The portable terminal according to claim 14, wherein, when the gesture sensor detects the gesture, the at least one projector projects the first UI or a third UI different from the first UI onto the object.

17. A portable terminal comprising:
at least one projector configured to project a first UI onto an object;
a gesture sensor configured to detect a gesture with respect to the first UI; and
a controller configured to control the at least one projector so that a second UI corresponding to the detected gesture is projected onto the object.

18. The portable terminal according to claim 17, wherein the at least one projector includes:
a light source configured to display the first UI or the second UI through a plurality of OLEDs; and
a lens configured to focus light generated in the plurality of OLEDs and project the light onto the object.

19. The portable terminal according to claim 18, wherein the lens is provided so that curvature thereof is reduced in a direction.

20. The portable terminal according to claim 18, wherein the at least one projector further includes a reflection mirror configured to change a path of the light generated in the plurality of OLEDs and transfer the light to the lens.

21. The portable terminal according to claim 20, wherein the at least one projector projects the first UI or the second UI at a location corresponding to an angle at which the light generated in the plurality of OLEDs is incident on the reflection mirror.

22. The portable terminal according to claim 17, further comprising a lifting member configured to move the at least one projector away from the object.

23. The portable terminal according to claim 22, wherein the at least one projector moved by the lifting member projects the first UI or the second UI at a location corresponding to a distance with the object.

24. A method of controlling a portable terminal comprising:
projecting, by at least one projector, a first UI onto an object;
detecting, by a gesture sensor, a gesture with respect to the first UI; and
providing, by a controller through the at least one projector, a second UI corresponding to the detected gesture.

25. The method according to claim 24, wherein the providing, by the controller, of the second UI corresponding to the detected gesture includes projecting the second UI corresponding to the detected gesture onto the object.

26. The method according to claim 24, wherein the providing, by the controller, of the second UI corresponding to the detected gesture includes displaying the second UI corresponding to the detected gesture on a display for the portable terminal.
